(19) United States
(12) Patent Application Publication
(10) Pub. No.: US 2008/0014795 A1
(43) Pub. Date: Jan. 17, 2008

(54) CONNECTOR

(75) Inventors: Harald Michael Lutsch, Ottrau (DE); Vladimir Buden, Zagreb (HR); Minja Adzic, Zagreb (HR)

Correspondence Address: SUGHRUE MION, PLLC, 2100 PENNSYLVANIA AVENUE, N.W., SUITE 800, WASHINGTON, DC, 20037, US

(73) Assignee: Yazaki Europe Ltd., Hertfordshire (GB)

(21) Appl. No.: 11/776,142

(22) Filed: Jul. 11, 2007

(30) Foreign Application Priority Data
Jul. 13, 2006 (DE) 10 2006 032 642.3

(51) Int. Cl. H01R 13/40

(52) U.S. Cl. 439/587

(57) ABSTRACT

A connector (1) for connection to another connect. The connector includes a housing having a plurality of first and second receiving chambers (3, 4) extending parallel to a longitudinal axis (5). The first receiving chambers (3) receive a contact element (14) connected to a cable (15). At mat seal (18, 19) is held between the housing (2) and a mat seal holder (22). Sealing elements (16) are removably connected to the mat seal holder (22) and include a sealing portion (17) which projects from the mat seal holder (22) into one of the apertures (20, 21) of the mat seal (18).

### BACKGROUND OF THE INVENTION

The invention relates to a connector which serves to be connected to a counter connector, comprising a housing which is provided with a plurality of first and second receiving chambers extending parallel to a longitudinal axis, wherein the first receiving chambers serve to receive a contact element connected to a cable and which housing, on its rear side, comprises openings of the receiving chambers, at least one mat seal which rests against the rear side of the housing and comprises apertures which are aligned with the openings, and at least one mat seal holder which is removably fixed to the rear side of the housing and comprises apertures which are aligned with the apertures of the at least one mat seal, wherein the at least one mat seal is held between the housing and the at least one mat seal holder.

Such a connector is shown in U.S. Pat. No. 4,944,688. The mat seal is held by a mat seal holder so as to rest against the rear side of the housing. The mat seal holder rests against the mat seal side facing away from the rear side and comprises fixing arms which embrace the mat seal, wherein the fixing arms extend behind locking projections of the housing. The mat seal holder is thus fixed to the housing. The mat seal is arranged and held between the housing and the mat seal holder. The mat seal holder comprises apertures which are aligned with the apertures of the mat seal, so that the cables of the contact elements can be guided out of the receiving chamber through the apertures of the mat seal and of the mat seal holder.

As connectors frequently comprise different configurations, i.e. depending on the configuration, they comprise a different number of contact elements in different receiving chambers, not all the receiving chambers of every configuration are provided with contact elements. In such cases it is necessary for those receiving chambers not provided with contact elements to be sealed. To avoid having to provide for every configuration a different mat seal which, in the region of the receiving chambers not provided with contact elements, does not comprise any apertures, it is proposed by U.S. Pat. No. 4,944,688 to provide the mat seal holder sealing with projections which close the apertures of the mat seal holder and which project into the apertures of the mat seal. The sealing projections are formed on to the mat seal holder and can be removed by a tool. The sealing projections are removed from those apertures which are aligned with those receiving chambers which are provided with contact elements. For this purpose, the sealing projections are broken off by the tool so that a cable of a contact element can be guided through the aperture of the mat seal holder.

The disadvantage of this solution is that, during assembly, initially all not required sealing projections have to be broken off and removed.

It is the object of the present invention to provide an initially mentioned connector which permits an easy assembly procedure.

### SUMMARY OF THE INVENTION

The objective is achieved in that there are provided sealing elements which are removably connected to the mat seal holder and that the sealing elements each comprise a sealing portion which projects from the mat seal holder and is sealingly positioned in one of the apertures of the at least one mat seal.

In this way, the first receiving chambers, i.e. the first partial number of all receiving chambers, are provided with contact elements and the second receiving chambers, i.e. a second partial number of all receiving chambers, are provided with sealing elements. As the sealing elements project from the mat seal holder and are positioned in the apertures of the mat seal, it is possible to use the same mat seal for each configuration. Furthermore, the same mat seal holder can be used for each configuration because, depending on the configuration, the sealing elements are releasably connected to the mat seal holder. For adapting the mat seal holder to the different configurations, there is no need for any elements of the mat seal holder to be broken off by a tool.

In a preferred embodiment, the sealing elements are connected to the mat seal holder via an engagement connection in the apertures of the mat seal holder.

As far as details are concerned, it is proposed that the sealing elements are inserted in parallel to the longitudinal axis into the apertures from the end of the mat seal holder, which faces away from the housing. The sealing elements, by means of a first supporting face are supported towards the housing against a second supporting face of the mat seal holder. Furthermore, the sealing elements each comprise a locking arm which, transversely to the longitudinal axis, is elastically deformable between a locking position and an unlocking position and forms a first locking face. In this way, the sealing elements, by means of the locking face, are able to support themselves in a direction facing away from the housing, against a second locking face of the mat seal holder.

To ensure that the sealing elements can easily be inserted into the apertures of the mat seal holder, the locking arms of the sealing element each form a setting face which is arranged so as to enclose an acute angle with the longitudinal axis and which, when the sealing element is being inserted, cooperates with the mat seal holder in such a way that the locking arm can be deformed transversely to the longitudinal axis from the locking position into the unlocking position.

Furthermore, it is possible to provide a secondary locking element which is movable at the housing between a locking position and a releasing position and which, in the locking position, projects by at least one locking projection into at least one receiving chamber.

The contact elements are prevented by the secondary locking element from being pulled out of the receiving chambers. The secondary locking element is movably attached at the housing between a locking position and a releasing position. There can be provided one or more secondary locking elements. For example, the secondary locking element can be slidably guided at the housing or pivotably attached thereto. The secondary locking element can comprise a locking projection which, in the locking position, projects simultaneously into several receiving chambers. With reference to the longitudinal extension of the receiving chamber, the locking projection engages the receiving chamber between the two ends of same transversely to the longitudinal extension of same. As usual, the contact elements comprise a locking face which supports the contact elements against one of the locking projections of the secondary locking element, when attempts are made to pull the contact element out of the receiving chamber.

### BRIEF DESCRIPTION OF THE DRAWINGS

A preferred embodiment will be described below in greater detail with reference to the following drawings wherein

FIG. 1 is a perspective view of an inventive connector;

FIG. 2 is a longitudinal section through the connector according to FIG. 1 with first receiving chambers provided with contact elements and second receiving chambers not provided with sealing elements;

FIG. 3 is a perspective view of an inventive sealing element; and

FIG. 4 is a perspective view of the mat seal holder, of a mat seal and of a sealing element.

### DETAILED DESCRIPTION OF THE INVENTION

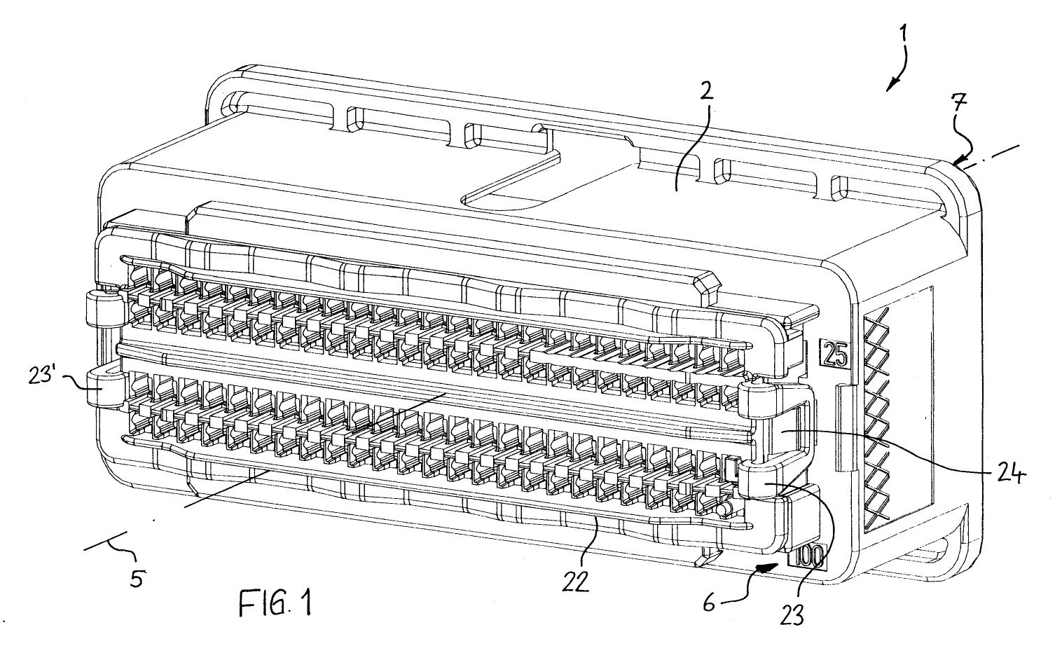

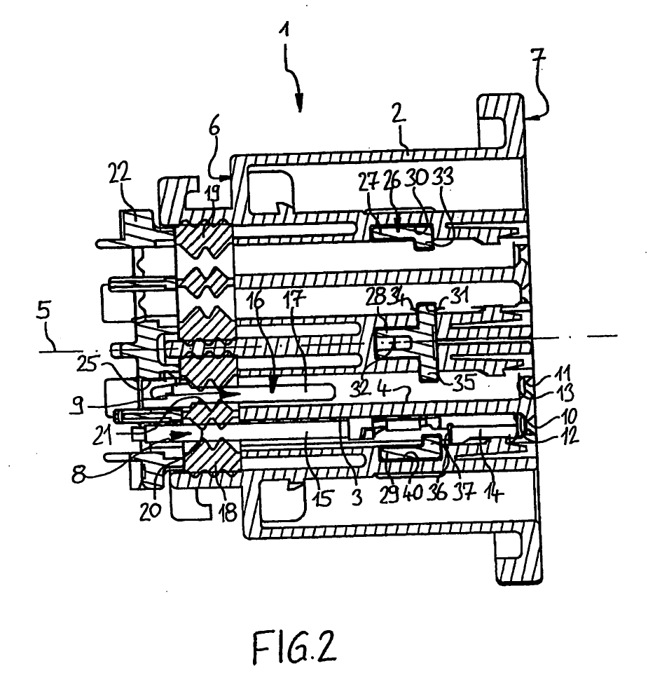

FIG. 1 is a perspective illustration of an inventive connector. FIG. 2 is a longitudinal section through the connector according to FIG. 1, with FIGS. 1 and 2 being described jointly below.

The connector 1 comprises a housing 2 in which there are provided first receiving chambers 3 and second receiving chambers 4 which are identical relative to one another. The receiving chambers 3, 4 are arranged so as to extend parallel to the longitudinal axis 5, with the connector 1, in the direction of the longitudinal axis 5, being connected to a counter connector.

The housing 2 comprises a rear side 6 and a front side 7 facing away therefrom. In the rear side 6, there are provided first rear side openings 8 which lead to the first receiving chambers 3, as well as second rear side openings 9 which lead to the second receiving chambers 4. In a cross-section viewed at a right angle relative to the longitudinal axis 5, the rear side openings 8, 9 have the same shape and size as the receiving chambers 3, 4.

The front side 7 comprises first front side openings 10 which lead to the first receiving chambers 3 as well as second front side openings 11 which lead to the second receiving chambers 4. In a cross-sectional view, the front side openings 10, 11 are smaller than the receiving chambers 3, 4, so that the first front side opening 10 forms an inwardly pointing continuous first supporting face 12 and the second front side opening 11 forms a second continuous inwardly pointing supporting face 13.

In the first receiving chambers 3 there are arranged contact elements 14 which are inserted from the rear side 6 through the first rear side openings 8 into the first receiving chambers 3. At their ends facing the rear side 6 of the housing 2, the contact elements 14 are each connected to a cable 15 which is guided out of the respective first rear side opening 8 out of the first receiving chamber 3. Towards the front side 7 of the housing 2, the contact elements 14 are supported against the first supporting faces 12 because, at an end directed towards the front side 7, the contact elements 14 comprise a larger cross-section than the first front side openings 10.

No contact elements are received in the second receiving chambers 4.

At the rear side 6, two mat seals 18, 19 rest against the housing 2. Per receiving chamber 3, 4, the mat seals 18, 19 comprise a aperture 20, 21 which are each aligned with one of the rear side openings 8, 9. For the purpose of sealing the receiving chambers 3, 4, the mat seals 18, 19 rest sealingly against the rear side 6 of the housing 2. Furthermore, the cables 15 are sealingly guided through a first number of apertures 20, 21.

On the rear side 6 of the housing 2, a mat seal holder 22 is connected to the housing 2, which mat seal holder 22, by means of fixing arms 23, engages behind fixing projections 24 of the housing 2 and is removably connected to the housing 2. The mat seals 18, 19 are arranged between the mat seal holder 22 and the rear side 6 of the housing and held therebetween. The mat seal holder 22, per aperture 20, 21 of the mat seals 18, 19, is provided with apertures 25 which are aligned with the apertures 20, 21 of the mat seals 18, 19, so that cables 10 can be guided through the apertures 25 of the mat seal holder 22.

At those apertures 21 which are aligned with second rear side openings 9 of the second receiving chambers 4 not provided with contact elements 14, the sealing elements 16 are removably fixed to the mat seal holder 22. The sealing elements 16 each comprise a sealing portion which projects from the mat seal holder 22 towards the mat seals 18, 19 and is sealingly positioned in one of the apertures 21 of the mat seals 19. It is thus ensured that all the receiving chambers 3, 4 are sealed towards the outside.

The contact elements 14 are secured by a secondary locking element 26 against being pulled out of the receiving chambers 3.

The secondary locking element 26 is comb-shaped, having a first arm 27, a second arm 28 and a third arm 29. By means of the arms 27, 28, 29, the secondary locking element 26 is guided in correspondingly designed guiding recesses 30, 31, 40 in the housing 2 so as to be displaceable transversely to the longitudinal axis 5 at the housing 2. The secondary locking element 26 is displaceable between a releasing position extracted out of the guiding recesses 30, 31, 40 and a locking position in which it is pushed into the guiding recess 30, 31, 40. The first arm 27 comprises a first locking projection which extends along a displacement axis 32 of the secondary locking element 26 and which extends partially transversely into a first partial number of receiving chambers, if the secondary locking element 26 is in its locking position. The second arm 28 comprises a second locking projection 34 which projects into a second partial number of receiving chambers 4. Furthermore, the second arm 28 comprises a third locking projection 35 which, in the locking position of the secondary locking element 26, projects into a third partial number of receiving chambers. A fourth locking projection 36 provided at the third arm 29 projects into a fourth partial number of the receiving chambers 3. FIG. 2, in a longitudinal section, shows how the fourth locking projection 36 projects into a first receiving chamber 3 and narrows the first receiving chamber 3 in a cross-sectional view. In the region of the fourth locking projection 36, the contact element 14 is narrower and comprises a locking face 37 which points towards the fourth locking projection 26 and which, in the case of an attempt to pull the contact element 14 out of the first receiving chamber 3, comes to rest against the fourth locking projection 36, so that the contact element 14 is supported and prevented from being pulled out.

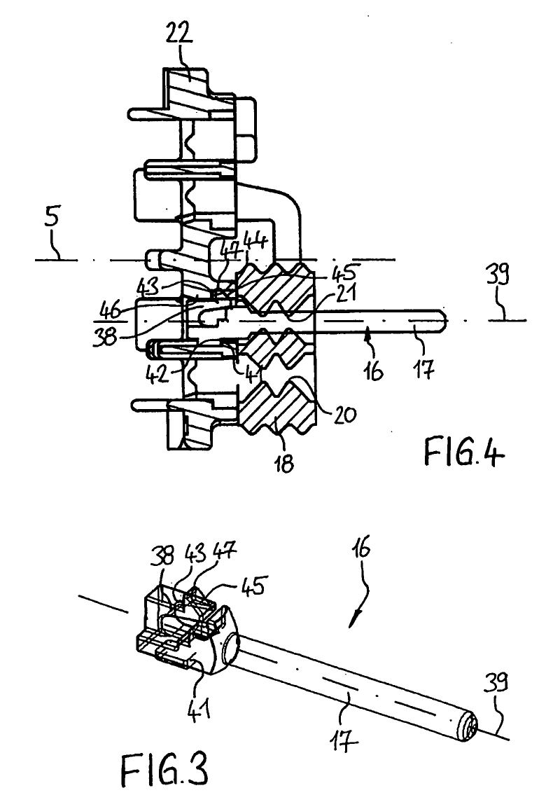

FIGS. 3 and 4 show in detail how the sealing elements 16 are designed and fixed to the mat seal holder 22.

The sealing element 16 is fixed via an engagement connection in the apertures 25 of the mat seal holder 22. For this purpose, the sealing element 16 comprises a first supporting face 41 which points towards the housing 2 and is supported against a second supporting face 42 of the mat seal holder 22. Furthermore, the sealing element 16 comprises a locking arm 38 which can be deformed transversely to the central axis 39 of the sealing element 16 between a locking position shown in FIGS. 3 and 4 and an unlocking position approaching the central axis 39.

The locking arm 38 is provided with a first locking face 43 which points away from the housing 2 and which is supported away from the housing 2 against a second locking face 44 of the mat seal holder 22. The sealing element 16 is thus secured against being pulled out of the aperture 25 of the mat seal holder 22. Furthermore, in the region of the aperture 25 of the mat seal holder 22, the sealing element 16 comprises a cross-section which approximately corresponds to the cross-section of the aperture 25 of the mat seal holder, so that the sealing element 16 cannot be tilted out of the aperture 25.

At the locking arm 38, there is provided a setting face 45 which, together with the central axis 39 and the longitudinal axis 5 respectively encloses an acute angle. While the sealing element 16 is being mounted, the setting axis 45 cooperates with the mat seal holder 22 in such a way that the locking arm 38 is deformed transversely to the central axis 39 and the longitudinal axis 5 respectively from the locking position into the unlocking position.

For the purpose of mounting the sealing element 16, it is inserted into a aperture 25 of the mat seal holder 22, starting from the side of the mat seal holder which faces away from the housing 2. As soon as the setting face 45 comes into contact with the mat seal holder 22, the locking arm 38—as the sealing element 16 continues to be inserted—is deformed towards the central axis 39 until it assumes the unlocking position. As soon as the sealing element 16 has been fully inserted into the aperture 25 of the mat seal holder 22, the setting face 45 has passed a projection 46 formed by the aperture 25, so that the locking arm 38 elastically springs back into the locking position. This has been made possible because the setting face 45 is formed by a cam 47 which projects away from the central axis 39 from the locking arm 38 and engages behind the projection 46 in the fully inserted position of the sealing element 16. In addition, the cam 47 forms the first locking face 43.

What is claimed is:

1. A connector which serves to be connected to a counter connector, comprising:
a housing having a plurality of first and second receiving chambers extending parallel to a longitudinal axis, wherein the first receiving chambers receive a contact element connected to a cable, said housing having, on a rear side, openings of the receiving chambers;
a mat seal which rests against the rear side of the housing and comprises apertures which are aligned with corresponding openings of the first and second receiving chambers;
a mat seal holder removably fixed to the rear side of the housing for retaining the mat seal between the mat seal holder and the housing, said mat seal holder having apertures which are aligned with the apertures of the mat seal; and
sealing elements removably connected to the mat seal holder, said sealing elements each including a sealing portion which projects from the mat seal holder and is sealingly positioned in one of the apertures of the mat seal.

2. A connector according to claim 1, wherein the sealing elements are connected to the mat seal holder via an engagement connection in the apertures of the mat seal holder.

3. A connector according to claim 2, wherein the sealing elements are extend parallel to the longitudinal axis into the apertures from the end of the mat seal holder, which faces away from the housing;
the sealing elements, by means of a first supporting face, are supported towards the housing against a second supporting face of the mat seal holder;
the sealing elements each comprise a locking arm which is elastically deformable transversely to the longitudinal axis between a locking position and an unlocking position and forms a first locking face; and
the sealing elements, by means of the first locking face, in a direction facing away from the housing, are supported against a second locking face of the mat seal holder.

4. A connector according to claim 3, wherein the locking arms of the sealing elements each comprise a setting face which is arranged so as to enclose an acute angle with the longitudinal axis and which, when the sealing element is being inserted, cooperates with the mat seal holder in such a way that the locking arm is deformable transversely to the longitudinal axis from the locking position into the unlocking position.
